(19) United States
(12) Patent Application Publication
(10) Pub. No.: US 2011/0113775 A1
(43) Pub. Date: May 19, 2011

(54) VALVE ACTUATOR FOR TURBOCHARGER SYSTEMS

(76) Inventor: Daryl A. Lilly, Winterset, IA (US)

(21) Appl. No.: 13/003,358

(22) PCT Filed: Jul. 9, 2009
(86) PCT No.: PCT/US09/50078

§ 371 Date: Jan. 10, 2011

Related U.S. Application Data
(60) Provisional application No. 61/079,703, filed on Jul. 10, 2008.

(51) Int. Cl. F02M 25/07; F02D 23/00

(52) U.S. Cl. 60/605.2; 60/605.1

(57) ABSTRACT

A turbocharger system for an engine is provided. The turbocharger system includes a low pressure turbocharger that has a low pressure compressor and a low pressure turbine and a high pressure turbocharger that has a high pressure compressor and a high pressure turbine. The turbocharger system further includes a bypass valve for controlling a gas stream hi the turbocharger system. The bypass valve includes an actuator operable to control the bypass valve, and the actuator is an electronic solenoid controlled hydraulic actuator with a position feedback sensor to detect the position of the bypass valve.

### CROSS-REFERENCE TO RELATED APPLICATION

This application claims benefit to U.S. Provisional Patent Application No. 61/079,703 filed Jul. 10, 2008, the disclosure of which is hereby incorporated by reference in its entirety.

### STATEMENT CONCERNING FEDERALLY SPONSORED RESEARCH OR DEVELOPMENT

Not applicable.

### FIELD OF THE INVENTION

The present invention relates to valves for turbocharger systems, and in particular to such a valve that is controlled by a solenoid valve.

### BACKGROUND OF THE INVENTION

Turbochargers have become popular for many different types of internal combustion engines, from large diesel engines to small gasoline engines. The purpose of the turbocharger in all of them is to provide a high pressure charge of a fluid or gas, typically air, to the combustion chamber of the engine. The turbocharger is typically driven by the exhaust of the engine, which is used to drive a rotatively-driven compressor that compresses the air or fluid that is introduced to the combustion chamber of the engine. As the pressure in the combustion chamber goes up, so does the pressure of the exhaust, creating a feedback loop that can create an overload condition for either the turbocharger or the engine.

To control the turbocharger so that it does not create an overload condition, a waste gate valve is typically employed in the exhaust circuit that diverts all or part of the exhaust gas away from the turbine drive of the compressor, so as to limit the pressure that the turbine of the turbocharger is subjected to. Thereby, the boost pressure that the turbocharger provides to the engine is limited at a maximum level to avoid damage to the engine or turbocharger.

In some turbocharger systems, two or more turbochargers are employed to operate under different conditions of the engine. A smaller, lower flow turbocharger will operate for lower engine speeds or lower load conditions of the engine, and a larger higher flow turbocharger will operate for higher engine speeds or more demanding conditions of the engine. These are known as turbocharger sequencing applications and may require several valves in the exhaust lines between the two turbochargers to direct exhaust to one or the other of the turbochargers, or to bypass one or both of them.

The valves that are used in turbocharger applications are subjected to extremely severe operating conditions, as they must operate over a large temperature range (typically −40° C.-800° C., sometimes up to 1000° C.), since the exhaust is extremely hot, and the exhaust contains corrosive and acidic materials. These valves, particularly valves in turbocharger sequencing applications, must have very low leakage characteristics so that exhaust gas does not escape to the engine compartment or elsewhere and, particularly for turbocharger sequencing applications, to improve the efficiency of the system. As a result of this requirement, most prior art turbocharger system exhaust valves have been poppet type valves, which traditionally leak less than butterfly valves.

Another consideration of these types of valves, in addition to maintaining low leakage through a wide temperature range, is maintaining low hysteresis through a wide temperature range. The valve is typically actuated by a pressure operated actuator and so the force that the valve exerts on the actuator at a given boost pressure should be the same whether the valve is being opened or being closed. That is, the relationship of the force required for a given opening of the valve should be the same, or as nearly the same as possible, whether the valve is being opened or being closed.

In addition, typically such valves are actuated in only one direction, either open or closed, and in the other direction are actuated by a spring. It is desirable to make the force of the spring as low as possible, while still ensuring complete actuation of the valve, for example, if the spring biases the valve closed, as is typical, then when biased closed the valve should be completely closed, and not excessively leak.

Further still, the actuators used to control such valves typically do not have high accuracy. In addition, only a low amount of force can be applied if the valve is directly controlled by a solenoid. Therefore, a need also exists for an improved actuator assembly.

### SUMMARY OF THE INVENTION

In some embodiments, the present invention provides a series sequential turbocharger system for an engine. The turbocharger system includes a low pressure turbocharger that has a low pressure compressor and a low pressure turbine. The low pressure compressor is rotatably coupled to the low pressure turbine. The low pressure compressor is in fluid communication with an intake manifold of the engine, and the low pressure turbine is in fluid communication with an exhaust manifold of the engine. The turbocharger system further includes a high pressure turbocharger that has a high pressure compressor and a high pressure turbine. The high pressure compressor is rotatably coupled to the high pressure turbine. The high pressure compressor is in fluid communication with the intake manifold of the engine, and the high pressure turbine is in fluid communication with an exhaust manifold of the engine. The turbocharger system further includes a bypass valve for controlling a gas stream in the turbocharger system. The bypass valve includes an actuator operable to control the bypass valve, and the actuator is an electronic solenoid controlled hydraulic actuator with a position feedback sensor to detect the position of the bypass valve.

In some embodiments of the invention, the turbocharger system may include an exhaust gas recirculation conduit in fluid communication with the exhaust manifold and the intake manifold, and a cooler fluidly positioned along the exhaust gas recirculation conduit and in fluid communication with the exhaust manifold and the intake manifold.

The foregoing and other objects and advantages of the invention will be apparent in the detailed description and drawings which follow. In the description, reference is made to the accompanying drawings which illustrate a preferred embodiment of the invention.

### BRIEF DESCRIPTION OF THE DRAWINGS

FIG. 1a is a schematic representation of a series sequential turbocharger system with valve assemblies according to the present invention;

FIG. 1b is a schematic representation of the series sequential turbocharger system of FIG. 1a with an exhaust gas recirculation conduit;

FIG. 1c is a schematic representation of valve assemblies according to the present invention;

FIG. 2 is a perspective view of a valve assembly incorporating the invention;

FIG. 3 is an exploded perspective of the valve assembly of FIG. 2;

FIG. 4 is a perspective sectional view of the valve assembly from the line 4-4 of FIG. 2 with a solenoid valve removed;

FIG. 5 is a perspective sectional view of an actuator housing from the line 4-4 of FIG. 2 with the solenoid valve shown in full;

FIG. 6 is a side view of the section shown in FIG. 4;

FIG. 7 is a side view of the section shown in FIG. 5;

FIG. 8 is an end plan view of a butterfly valve of FIG. 2;

FIG. 9 is a cross-sectional view of the butterfly valve from the plane of the line 9-9 of FIG. 8;

FIG. 10 is a cross-sectional view of the butterfly valve from the plane of the line 10-10 of FIG. 8; and

FIG. 11 is a cross-sectional view of a butterfly valve with an alternative housing and bushing design.

### DETAILED DESCRIPTION OF THE PREFERRED EMBODIMENT

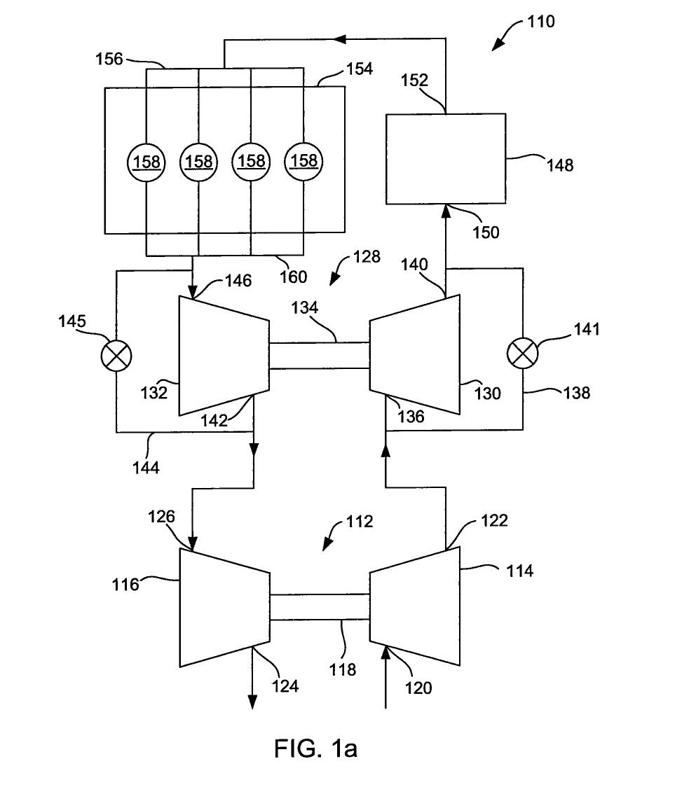

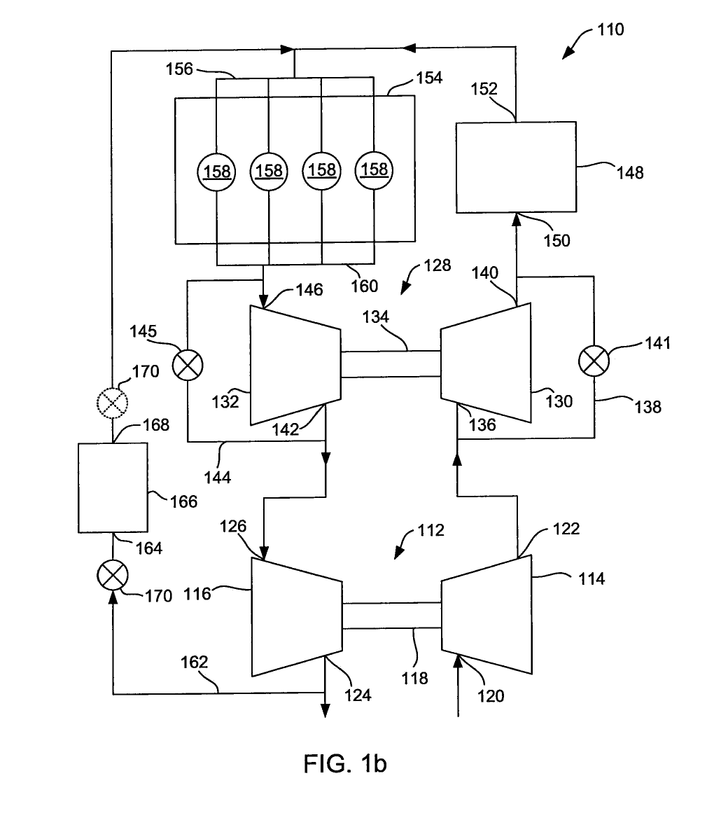

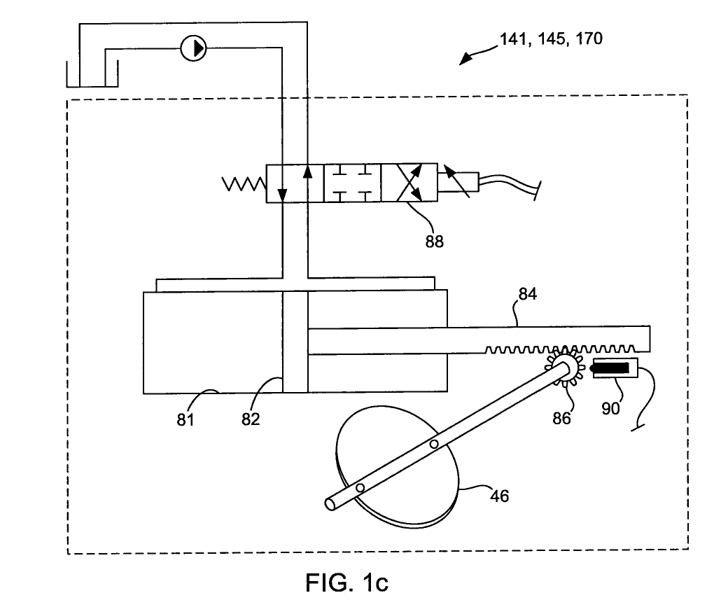

FIG. 1a shows a schematic representation of a series sequential turbocharger system 110. The system includes a low pressure turbocharger 112 having a low pressure compressor 114 and a low pressure turbine 116. A shaft 118 rotatably connects the low pressure compressor 114 and the low pressure turbine 116. The low pressure compressor 114 includes an inlet 120 that preferably fluidly communicates with the air filter (not shown) of the vehicle. The low pressure compressor 114 also includes an outlet 122 that fluidly communicates with other components of the system 110, as described below. The low pressure turbine 116 includes an outlet 124 that preferably fluidly communicates with the exhaust line (not shown) of the vehicle. The low pressure turbine 116 also includes an inlet 126 that fluidly communicates with other components of the system 110, as described below.

The system 110 includes a high pressure turbocharger 128 having a high pressure compressor 130 and a high pressure turbine 132. A shaft 134 rotatably connects the high pressure compressor 130 and the high pressure turbine 132. The high pressure compressor 130 includes an inlet 136 that fluidly communicates with the outlet 122 of the low pressure compressor 114 and a compressor bypass conduit 138. The high pressure compressor 130 also includes an outlet 140 that fluidly communicates with the compressor bypass conduit 138. It should be noted that a compressor bypass valve 141 is located on the compressor bypass conduit 138 separating the ends connecting to the inlet 136 and the outlet 140 of the high pressure compressor 130. The compressor bypass valve 141 is preferably a valve assembly according to the present invention. The high pressure turbine 132 includes an outlet 142 that fluidly communicates with the inlet 126 of the low pressure turbine 116 and a turbine bypass conduit 144. The high pressure turbine 132 also includes an inlet 146 that fluidly communicates with the turbine bypass conduit 144. It should be noted that a turbine bypass valve 145 is located on the turbine bypass conduit 144 separating the ends connecting to the inlet 146 and the outlet 142 of the high pressure turbine 132. The turbine bypass valve 145 is also preferably a valve assembly according to the present invention.

The outlet 140 of the high pressure compressor 130 and the compressor bypass conduit 138 fluidly communicate with an inlet 150 of a charge air cooler 148. An outlet 152 of the charge air cooler 148 fluidly communicates with an intake manifold 156 of an engine block 154. The engine block 154 includes a plurality of combustion cylinders 158. Four combustion cylinders 158 are included in this system. However, those skilled in the art will recognize appropriate changes to apply the present invention to an engine with any number or configuration of combustion cylinders. The engine block 154 also includes an exhaust manifold 160 that fluidly communicates with the inlet 146 of the high pressure turbine 132 and the turbine bypass conduit 144.

It should be understood that the turbocharger system 110 shown in FIG. 1a is just one application to which a valve assembly of the present invention could be applied. The application shown in FIG. 1a is a system to which the invention is particularly applicable, since very low leakage, low hysteresis valves are especially needed in such applications. However, a valve assembly of the invention could be applied at different locations in a turbocharger system. For example, referring to FIG. 1b, the turbocharger system 110 may include an exhaust gas recirculation (EGR) conduit 162 with such a valve. Specifically, the intake manifold 156 and the outlet 124 of the low pressure turbine 116 fluidly communicate through an EGR conduit 162. The EGR conduit 162 fluidly communicates with an inlet 164 of a cooler 166 through an EGR valve 170, thereby providing a hot-side EGR valve. Alternatively, an outlet 168 of the cooler 166 may fluidly communicate with the intake manifold 156 through the EGR valve 170, thereby providing a cold-side EGR valve. The EGR valve 170 is preferably a valve assembly as discussed below.

Referring to FIG. 1c, a schematic of the valves 141, 145 and 170 is shown. Each valve is connected to a pump that supplies hydraulic fluid and to a tank or reservoir that stores hydraulic fluid. The hydraulic circuit may also include other well-known components, such as filters and pilot-operated relief valves. Each of the valves 141, 145 and 170 includes a three position, four way solenoid-controlled valve 88, a hydraulic actuator, and a butterfly valve element 46. The solenoid-controlled valve 88 is preferably a spring return valve that is normally in the position shown in FIG. 1c. The normal position of the solenoid-controlled valve 88 results in the butterfly valve element 46 being normally closed as described below. The solenoid-controlled valve 88 is preferably selectively actuated with a pulse-width modulation signal.

The hydraulic actuator is in fluid communication with the pump and the tank through the solenoid-controlled valve 88. The hydraulic actuator includes an actuator chamber 81, a piston 82, and a rack 84. The actuator chamber 81 receives hydraulic fluid and moves the piston 82 depending on which part of the chamber is coupled to the pump. The piston 82 and the rack 84 of the hydraulic actuator are preferably normally extended due to the normal position of the solenoid-controlled valve 88. The solenoid-controlled valve 88 is selectively actuated to pressurize the rod side of the actuator chamber 81 to vary the position of the piston 82 and the rack 84.

The butterfly valve element 46 is as described below and connects to a pinion 86. The pinion 86 includes a plurality of teeth that engage teeth of the rack 84. Therefore, extension and retraction of the piston 82 and the rack 84 cause rotation of the pinion 86 and the butterfly valve element 46. The butterfly valve element 46 is preferably normally closed due to hydraulic pressure, and selectively actuating the solenoid-controlled valve 88 varies the opening of the butterfly valve element 46. A rotary position sensor 90 for providing feedback for controlling the position of the pinion 86 is also preferably provided.

The valves 141, 145 and 170 are preferably valve assemblies 10 as described below. Although the valve assembly 10 is shown and described as a butterfly valve, the actuator assembly may be used to control any type of valve. For example, the actuator assembly may be used to control a rotational poppet valve, a stem valve, or any other valve that is well known in the art.

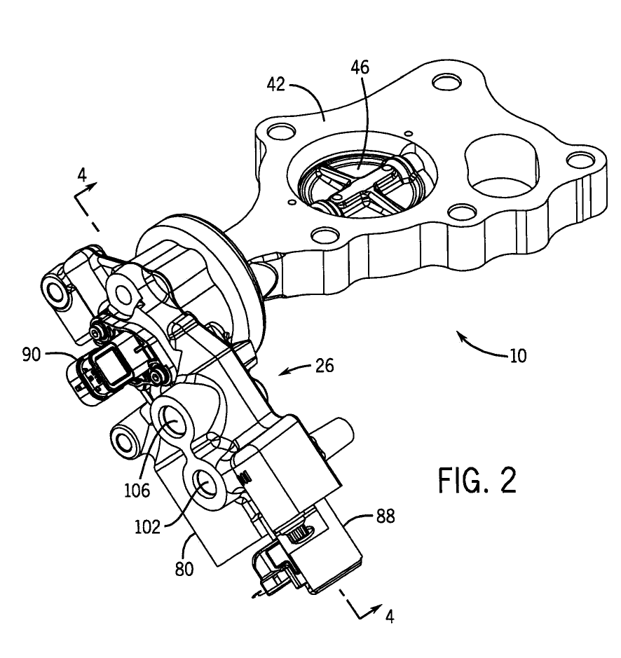

Referring to FIG. 2, a valve assembly 10 incorporates a butterfly valve element 46 located within a housing 42. The physical design of the housing 42 may be modified depending on the location of the valve assembly 10 within the turbocharger system 110.

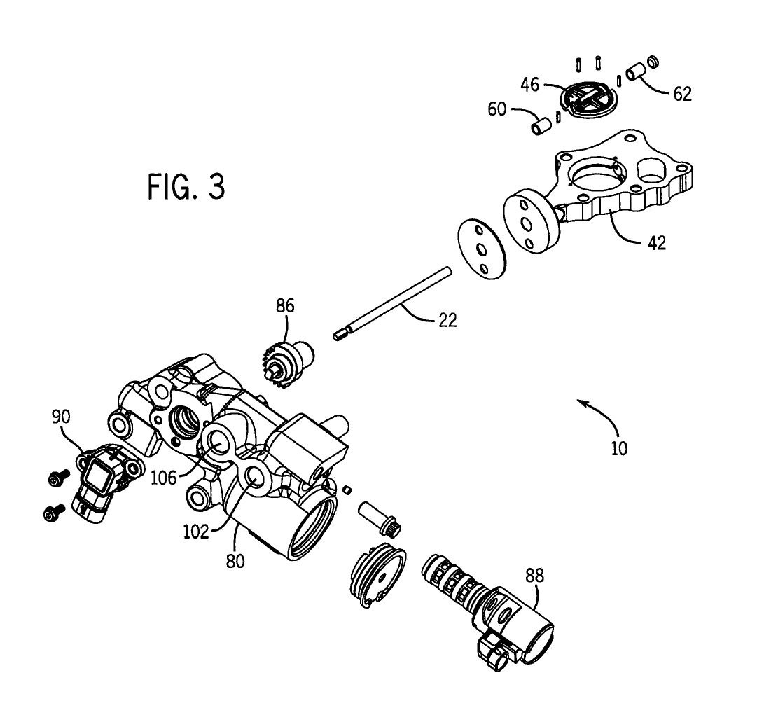

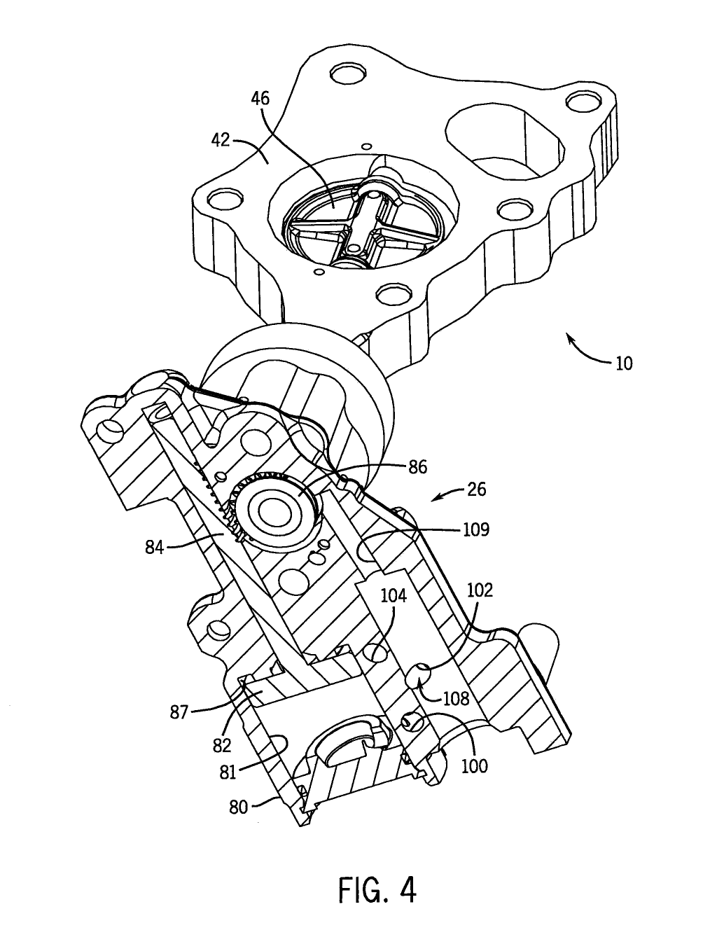

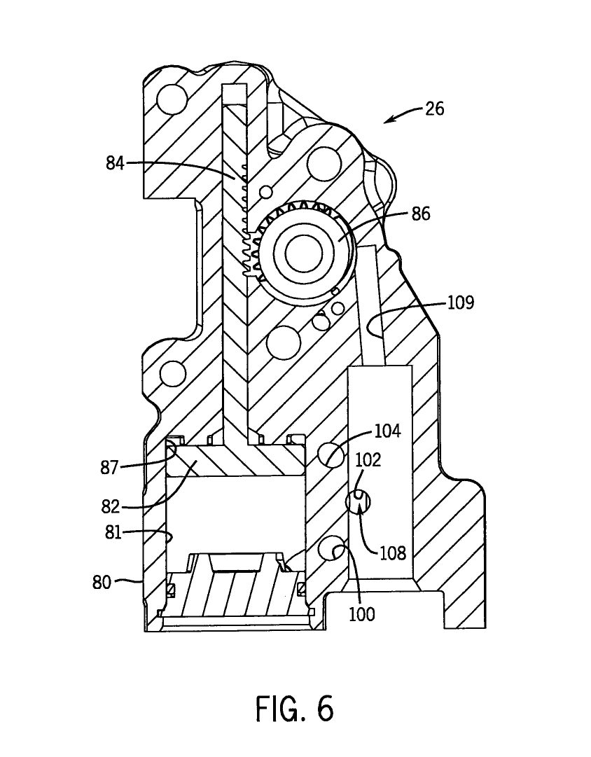

Referring to FIGS. 2-7, the electro-hydraulic actuator assembly 26 is preferably a high torque, high resolution actuator that includes an actuator housing 80 that defines a variable volume pressurized fluid actuator chamber 81 and encloses the piston 82 connected to the rack 84. The actuator chamber 81 is preferably fed by the same pressurized fluid system that feeds bearings of the turbocharger. This may be the pressurized engine oil lubrication system, for example. With such a system the pressure varies with engine speed. However, the actuator assembly 26 may use other fluids besides hydraulic fluids. The rack 84 translates linearly inside the actuator housing 80 to rotate the pinion 86, as discussed above. The pinion 86 is rotatably fixed to the shaft 22 and therefore the butterfly valve element 46. The orientation of the butterfly valve element 46, and therefore the degree of opening, is varied by actuation of the piston 82.

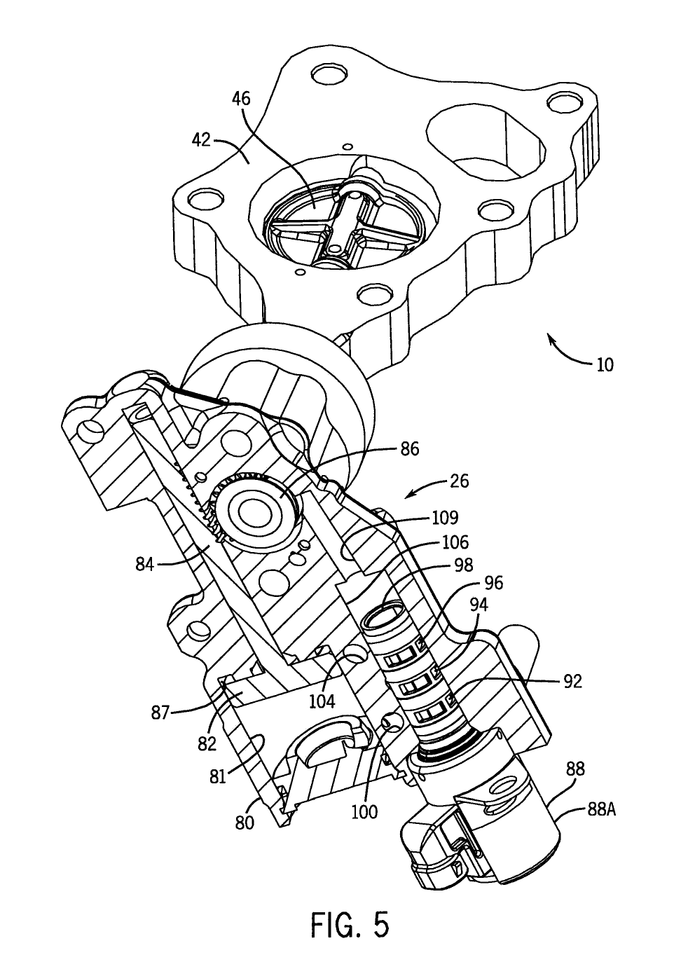

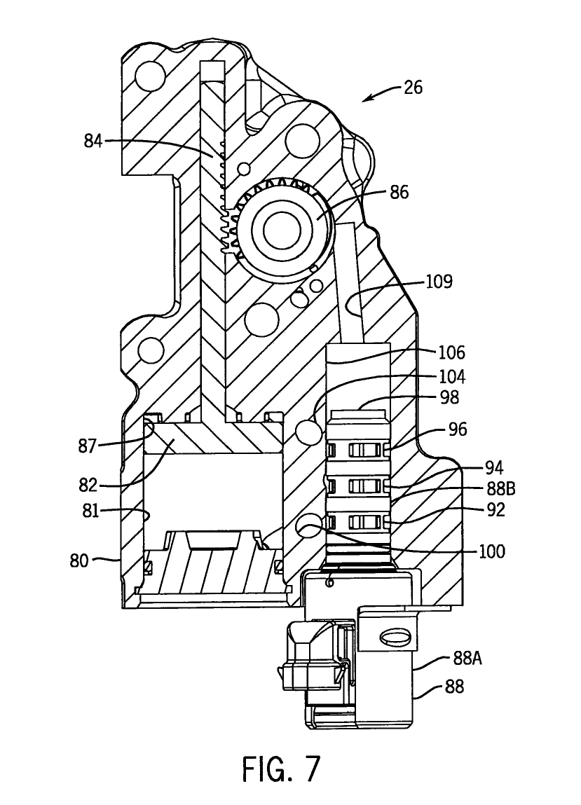

The electro-hydraulic actuator assembly 26 also preferably includes a cartridge-type solenoid-controlled valve 88 to control the amount of hydraulic fluid supplied to the actuator chamber 81. Referring to FIGS. 5 and 7, a port section 88B of the solenoid valve 88 includes multiple ports, including bore port 92, pump port 94, rod port 96, and tank port 98. Accordingly, referring to FIGS. 2-4 and 6, the actuator housing 80 includes multiple passageways corresponding to the ports of the solenoid valve 88, including bore passageway 100, pump passageway 102, rod passageway 104, and tank passageway 106. Normally the bore passageway 100 is connected to the pump passageway 102 and the rod passageway 104 is connected to the tank passageway 106 through the ports of the solenoid valve 88. This holds the butterfly valve element 46 in the normally closed position. Actuation of the solenoid valve 88 changes the port connections, and therefore the bore passageway 100 connects to the tank passageway 106 and the rod passageway 104 connects to the pump passageway 102. This moves the butterfly valve element 46 to an open position.

In addition, the actuator housing 80 includes drain line passageway 108 and a gear cavity passageway 109. The drain line passageway 108 is in fluid communication with the pump passageway 102 and the housing cavity in which the rack 84 and pinion 86 engage one another. The gear cavity passageway 109 is in fluid communication with the tank passageway 106 and the housing cavity in which the rack 84 and pinion 86 engage one another. This provides lubrication to the rack 84 and the pinion 86. However, the resistance to flow along these passageways is preferably relatively high so that all hydraulic fluid does not flow from directly from pump back to tank; that is, a relatively low resistance to flow along these passageways would prevent the hydraulic fluid from moving the piston 82.

The amount of hydraulic fluid supplied to the actuator chamber 81 may be varied, for example, according to engine speed. The electro-magnetic solenoid valve 88 is preferably pulse width modulation (PWM) controlled, as discussed above. The electro-hydraulic actuator assembly 26 also preferably includes the rotary position feedback sensor 90 to monitor and control the angular orientation of the butterfly valve element 46 in a closed-loop manner. The rotary position feedback sensor 90 may be a hall effect sensor on the pinion shaft. The rotary position feedback sensor 90 is preferably sealed within a compartment of the actuator housing 80 for protection from the hydraulic fluid.

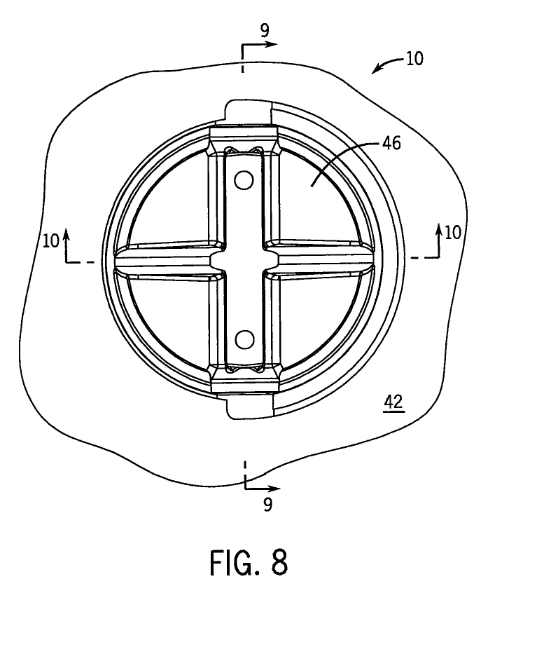

Referring to FIGS. 8-10, the internal construction the housing 42 is shown. The housing 42 includes a valve passageway 44 that extends from one end of the housing 42 to the other. The butterfly valve element 46 that is positioned in the passageway 44 is generally circular and can be rotated about the axis 58 of shaft 22 so that it is either blocking the passageway 44, or allowing passage of gas through the passageway 44 in varying amounts. When it is fully open, the butterfly valve element 46 is oriented in a plane that is substantially perpendicular to the plane in which it lies in FIGS. 8-10, which is the closed position, so that when open substantially only its thickness dimension is presented to the flow of gas in the passageway. As such, the flow of gas can pass the butterfly valve element 46 on both sides of it and since the shaft is in the middle of the valve, the valve is generally balanced by the stream of gas. When the butterfly valve element 46 is closed (FIGS. 8-10), it seats against lap seating surfaces 48 and 50 that are formed in the passageway on the housing on opposite sides of the passageway and facing opposite ends of the valve. The axis 58 about which the butterfly valve element 46 is turned is between the two lap seating surfaces 48 and 50, and is the axis of shaft 22. Pressurizing the bore side 81 of the actuator 80 closes the butterfly valve element 46 and pressurizing the rod side 87 of the actuator 80 opens the butterfly valve element 46.

Shaft 22 extends into bores 54 and 56 on opposite sides of the passageway 44, which are also aligned along the shaft axis 58. Bushings 60 and 62 are pressed into the respective bores 54 and 56 such that they do not turn relative to the housing 42 and are fixed along the axis 58 relative thereto. The bushings 60 and 62 journal the shaft 22 and also extend into butterfly counter bores 66 and 68 that are formed in opposite ends of the bore through the butterfly valve element 46 through which the shaft 22 extends. Pins 70 keep the butterfly valve element 46 from turning too much relative to the shaft 22, as they are pressed into holes in the shaft 22. The holes in the butterfly valve element 46 through which the pins 70 extend may be slightly larger than the pins 70 so they do not form a fixed connection with the butterfly element 46, so as to permit it some freedom of relative movement. Thus, the butterfly 46 can, to a limited extent, turn slightly relative to the shaft 22, and move along the axis 58 relative to the shaft 22, limited by the pins 70 and the other fits described herein.

A cap 74 is preferably pressed into the bore 56, to close off that end of the assembly. The shaft 22 extends from the opposite end, out of bore 54, so that it can be coupled to an actuator, for example like the actuator assembly 26. A seal pack (not shown) can be provided between the shaft 22 and the bore 54 to inhibit leakage into or out of the valve, and a backer ring (not shown) may be pressed into the bore 54 to hold in the seal pack. The lap seating surfaces 48 and 50 are actually spaced by approximately the thickness of the butterfly valve element 46 and seal against the butterfly valve element 46 on their respective sides of the axis 58. In order to form these seals, the butterfly valve element 46 must be free to lay flat against the lap seating surfaces in the closed position of the valve. That is nearly impossible to do unless there is sufficient clearance built into the rotary joints that mount the butterfly valve element. The problem is that too much tolerance results in a leaky valve.

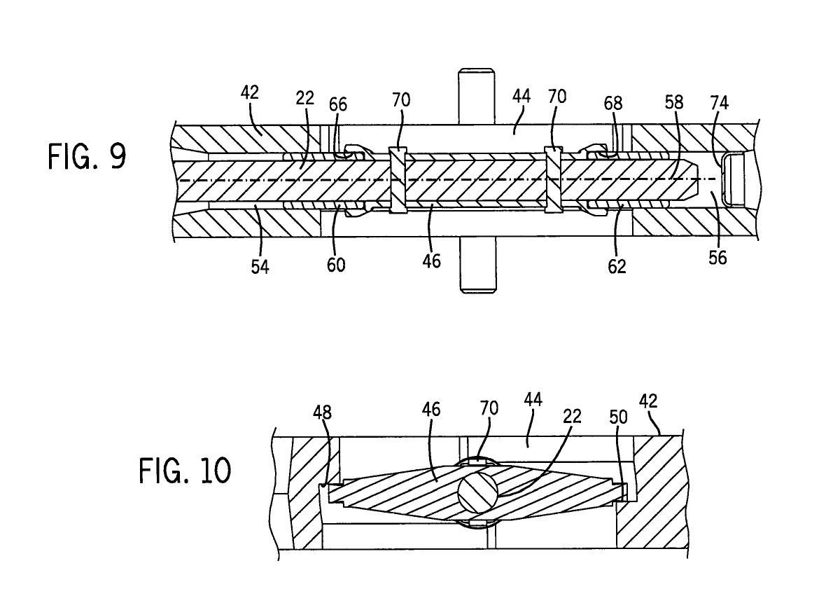

There is one slip fit between the bushings 60, 62 and their respective counter bores 68, 66, and there is another slip fit between the shaft 22 and the bushings 60, 62. It has been found that the leakage through the valve passageway 44 can be best controlled by making one of these fits a close running fit, and the other of these fits a medium or loose running fit. It is somewhat preferable to make the bushing-to-counter bore fit a close fit and the shaft-to-bushing fit the looser fit because providing the looser fit at the smaller diameter results in less overall leakage. However, either possibility has been found acceptable. In addition, as shown in FIG. 9, the bushing-to-counter bore interface is preferably shorter than the shaft-to-bushing interface. Providing the bushing-to-counter bore interface as a close fit and a short interface reduces leakage and permits the butterfly valve element 46 to move to a limited extent relative to the bushings 60 and 62 and the shaft 22 so that the butterfly valve element 46 seats flatly against the housing 42.

Choice of materials has also been found important to reduce the hysteresis of the valve. In addition, sets of materials can be selected based on the temperature range of the application. For example, an operating temperature above 850° C. may correspond to one set of materials and an operating range between 850° C.-750° C. may correspond to another set of materials. It should also be recognized that similar materials may gall under high temperature and pressure. As such, the materials for the components of the butterfly valve 40 are preferably as follows: the housing 42 is cast steel or an HK30 austenitic stainless steel alloy, the butterfly valve element 46 is cast steel, the shaft 22 is stainless steel and the bushings 60 and 62 are a steel that is compatible with the operating temperature and coefficient of thermal expansion of the other materials. If the valve assembly 10 is used as a turbine bypass valve 145, the shaft 22 and the butterfly valve element 46 may be stainless steel, the bushings 60 and 62 may be a cobalt/steel alloy, such as Tribaloy. Some applications may not require these materials or different combinations of these materials. For example, if the butterfly valve 40 is to be used in a low temperature application, the housing 42 may be high silicon molybdenum steel.

In an actual example, the fit of the bushings 60 and 62 to the counter bores 68 and 66 is that the OD of the bushings 60 and 62 is preferably 12.500 mm+0.000-0.011 mm and the ID of the counter bores 68 and 66 is preferably 12.507 mm+0.000-0.005 mm. These dimensions provide a maximum material condition of 0.002 mm. In the same application, the OD of the shaft is preferably in the range of 8.985 mm+0.000-0.015 mm and the ID of the bushing 60 and 62 is preferably in the range of 9.120 mm±0.015 mm. These dimensions provide a maximum material condition of 0.020 mm.

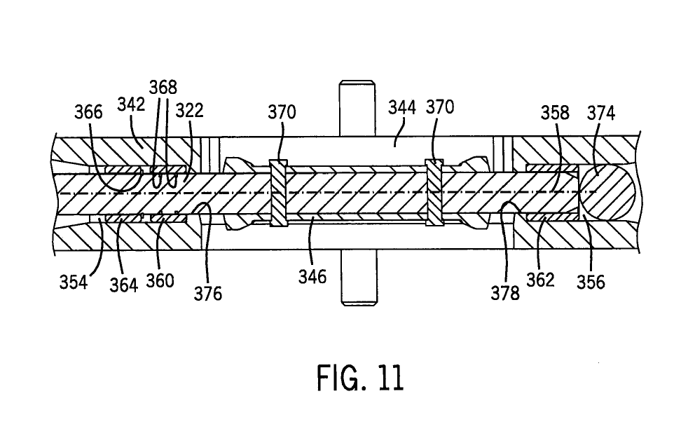

Referring to FIG. 11, an alternative embodiment for the housing, bushings, and butterfly valve element is shown. Like the first embodiment of the butterfly valve, the housing 342 includes a valve passageway 344, bores 354 and 356, and houses bushings 360 and 362, a shaft 322 with a longitudinal axis 358, a butterfly valve element 346 connected to the shaft 322 by pins 370, and a cap 374. However, several of the components of the alternative embodiment differ from those of the first embodiment of the butterfly valve. For example, the butterfly valve element 346 does not include counter bores. In addition, the bores 354 and 356 include reduced-diameter sections 376 and 378, respectively, that separate the bushings 360 and 362 from the valve passageway 344. The sections 376 and 378 create a shaft-to-housing interface. Further still, the bore 354 includes two bushings 360 and 364 and rings 366 and 368 positioned on the shaft 322.

For the embodiment of the butterfly valve element shown in FIG. 11, the shaft-to-housing fit is preferably the looser fit and the shaft-to-bushing fit is preferably the close fit. Advantageously, the alternative embodiment of the butterfly valve does not have a leak path around the inner end of the bushings like the first embodiment of the butterfly valve. However, the first embodiment of the butterfly valve is less expensive and easier to manufacture than the alternative embodiment of the butterfly valve.

A preferred embodiment of the invention has been described in considerable detail. Many modifications and variations to the embodiment described will be apparent to those skilled in the art. Therefore, the invention should not be limited to the embodiment described, but should be defined by the claims which follow.

I claim:

1. A series sequential turbocharger system for an engine, the turbocharger system comprising:
a low pressure turbocharger having a low pressure compressor and a low pressure turbine, the low pressure compressor being rotatably coupled to the low pressure turbine, and the low pressure compressor being in fluid communication with an intake manifold of the engine, and the low pressure turbine being in fluid communication with an exhaust manifold of the engine;
a high pressure turbocharger having a high pressure compressor and a high pressure turbine, the high pressure compressor being rotatably coupled to the high pressure turbine, the high pressure compressor being in fluid communication with the intake manifold of the engine, and the high pressure turbine being in fluid communication with an exhaust manifold of the engine; and
a bypass valve for controlling a gas stream in the turbocharger system, the bypass valve including an actuator operable to control the bypass valve, and the actuator is an electronic solenoid controlled hydraulic actuator with a position feedback sensor to detect the position of the bypass valve.

2. The system of claim 1, wherein the actuator includes a hydraulic cylinder and a solenoid controlling a hydraulic valve, and the hydraulic valve supplies hydraulic fluid to the hydraulic cylinder.

3. The system of claim 2, wherein the hydraulic cylinder includes a piston that moves a gear rack linearly.

4. The system of claim 3, wherein the gear rack rotates a pinion gear to change the position of the bypass valve so as to vary a bypass flow rate of the gas stream through the bypass valve.

5. The system of claim 1, wherein the position feedback sensor includes a hall effect rotary sensor to provide feedback for position control of a butterfly valve element.

6. The system of claim 1, wherein the solenoid is pulse width modulation controlled.

7. A valve for controlling a gas stream in a turbocharger system, the valve being fluidly positioned along a conduit of the turbocharger system, and the valve comprising:
a housing having a valve passageway through which exhaust gases pass from a first end to a second end of the valve; and
an electronic solenoid controlled hydraulic actuator operable to control the valve, and the actuator including a position feedback sensor to detect a position of the valve.

8. The system of claim 7, wherein the actuator includes a hydraulic cylinder and a solenoid controlling a hydraulic valve, and the hydraulic valve supplies hydraulic fluid to the hydraulic cylinder.

9. The system of claim 8, wherein the hydraulic cylinder includes a piston that moves a gear rack linearly.

10. The system of claim 9, wherein the gear rack rotates a pinion gear to change the position of the valve so as to vary a flow rate of the gas stream through the valve.

11. The system of claim 7, wherein the position feedback sensor includes a hall effect rotary sensor to provide feedback for position control of a butterfly valve element.

12. The system of claim 7, wherein the solenoid is pulse width modulation controlled.

13. A series sequential turbocharger system for an engine, the turbocharger system comprising:
a low pressure turbocharger having a low pressure compressor and a low pressure turbine, the low pressure compressor being rotatably coupled to the low pressure turbine, and the low pressure compressor being in fluid communication with an intake manifold of the engine, and the low pressure turbine being in fluid communication with an exhaust manifold of the engine;
a high pressure turbocharger having a high pressure compressor and a high pressure turbine, the high pressure compressor being rotatably coupled to the high pressure turbine, the high pressure compressor being in fluid communication with the intake manifold of the engine, and the high pressure turbine being in fluid communication with an exhaust manifold of the engine;
an exhaust gas recirculation conduit in fluid communication with the exhaust manifold and the intake manifold;
a cooler fluidly positioned along the exhaust gas recirculation conduit and in fluid communication with the exhaust manifold and the intake manifold; and
a bypass valve for controlling a gas stream in the turbocharger system, the bypass valve including an actuator operable to control the bypass valve, and the actuator is an electronic solenoid controlled hydraulic actuator with a position feedback sensor to detect the position of the bypass valve.

14. The system of claim 13, wherein the actuator includes a hydraulic cylinder and a solenoid controlling a hydraulic valve, and the hydraulic valve supplies hydraulic fluid to the hydraulic cylinder.

15. The system of claim 14, wherein the hydraulic cylinder includes a piston that moves a gear rack linearly.

16. The system of claim 15, wherein the gear rack rotates a pinion gear to change the position of the bypass valve so as to vary a bypass flow rate of the gas stream through the bypass valve.

17. The system of claim 13, wherein the position feedback sensor includes a hall effect rotary sensor to provide feedback for position control of a butterfly valve element.

18. The system of claim 13, wherein the solenoid is pulse width modulation controlled.
